(19) United States
(12) Patent Application Publication
(10) Pub. No.: US 2011/0121611 A1
(43) Pub. Date: May 26, 2011

(54) PLASTIC SCUTTLE GRILLE FOR VEHICLE WITH DETACHABLE PART

(75) Inventors: Eric Tarenberque, Bievres (FR); Christophe Escalere, Issy Les Moulineaux (FR); Yannick Le Roch, Saint Leger En Yvelines (FR); Christophe Blanc, Chateauroux Cedex (FR)

(73) Assignee: RENAULT s.a.s., Boulogne-Billancourt (FR)

(21) Appl. No.: 12/988,639

(22) PCT Filed: Apr. 10, 2009
(86) PCT No.: PCT/FR09/50656

§ 371 Date: Feb. 8, 2011

(30) Foreign Application Priority Data
Apr. 21, 2008 (FR) 0802204

(51) Int. Cl. B62D 25/00

(52) U.S. Cl. 296/193.1

(57) ABSTRACT

A plastic scuttle grill for a vehicle, including at least one fixed part to be attached rigidly to the vehicle, and at least one removable part including at least one mechanism of reversible attachment configured to engage with a corresponding attachment mechanism on the fixed part of the scuttle grill so that the removable part can be attached to or detached from at least one fixed part of the grill.

The invention relates to a plastic scuttle grille for a vehicle provided with a removable part.

A vehicle, in particular a motor vehicle, today comprises an increasing number of plastic elements, usually made in one piece. It is sometimes necessary to gain access to the pieces or parts of the vehicle that are situated behind such plastic elements, or inside the latter.

This is the case, for example, of the scuttle grilles which are situated along the front hood of the vehicle beneath the windshield. These grilles are made in one piece which extends over the whole width of the vehicle and comprise seals resting on the windshield. In certain vehicles, the windshield can be relatively far forward, the scuttle grille then being well toward the front of the vehicle. Because of this, it is difficult to gain access to the pieces of the vehicle that are situated beneath the forward position of the windshield without removing the scuttle grille. Such a removal is difficult and time-consuming, which complicates the inspection or replacement of the pieces to which it is necessary to be able to gain access.

The object of the invention is to alleviate these drawbacks by proposing a plastic scuttle grille of a vehicle provided with a removable part, the latter being able to be simply positioned and removed, allowing simple and rapid access to pieces situated behind the grille.

Accordingly, the subject of the invention is a plastic scuttle grille of a vehicle, characterized in that it comprises at least one fixed part designed to be rigidly fixed to the vehicle, and at least one removable part provided with at least one reversible fastening means capable of interacting with a corresponding fastening means of the fixed part of the grille in order to allow the fastening or removal of said removable part onto or from at least one fixed part of the grille.

The removable part can therefore be mounted or removed very simply and rapidly.

Advantageously, at least one portion of the periphery of the removable part is provided with a seal.

Advantageously, the fastening means are designed so as to be able to be manipulated by hand. No tool is therefore necessary, which makes the mounting/removal of the removable part easier.

In a particular embodiment, the fastening means are clips.

Each clip is for example formed of a tongue bent in a V shape of which the free end protrudes from the removable part on the opposite side of the scuttle grille. The clip can therefore be easily released by taking hold of this free end and closing the V of the clip.

Advantageously, the plastic scuttle grille comprises at least one removable part and at least two fixed parts.

The removable part can then form the central part of the scuttle grille.

The scuttle grille is therefore, for example, made in three distinct parts: two end parts designed to be permanently fixed to the vehicle, which parts are connected by a removable central part which is reversibly fastened to each of the end parts.

The invention is now described with reference to the appended, nonlimiting, drawings in which:

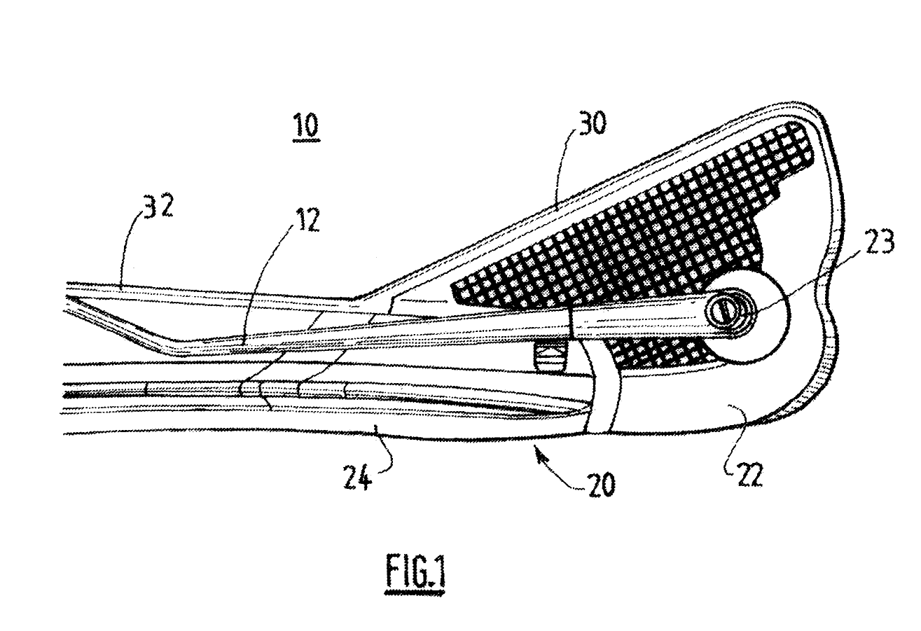

FIG. 1 represents a view of a front portion of a motor vehicle, and more particularly represents a plastic scuttle grille according to the present invention, and the bottom portion of the windshield;

FIG. 2 is a view identical to FIG. 1, the removable central part of the scuttle grille being removed,

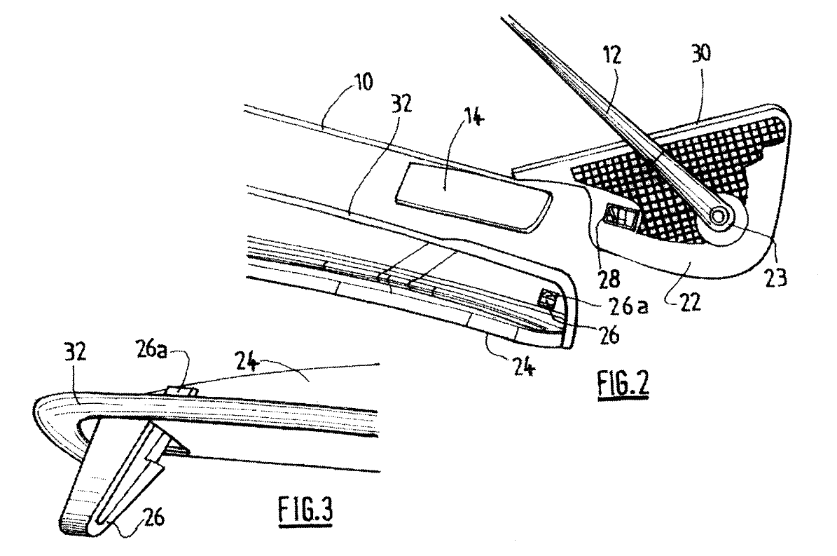

FIG. 3 represents a detail view of a means for fastening the removable central part shown in FIGS. 1 and 2.

FIG. 1 represents partially the bottom portion of a windshield 10, a windshield wiper 12 and a scuttle grille 20 of the front of a motor vehicle.

According to the invention, the scuttle grille 20 comprises at least one fixed part designed to be rigidly fixed to the vehicle, and at least one removable part provided with at least one reversible fastening means capable of interacting with a corresponding fastening means of the fixed part of the grille in order to allow said removable part to be fastened or removed to or from at least one fixed part of the grille.

In the example shown, the scuttle grille 20 comprises two fixed end parts 22 and one central removable part 24. For reasons of clarity, only one of the fixed end parts 22 is shown in FIGS. 1 and 2.

The two fixed end parts 22 are designed to be mounted permanently on the vehicle on either side of the windshield. In the example, these fixed end parts are meshed and are each provided with an orifice 23 allowing the drive shaft of the windshield wiper 12 to pass through.

These two fixed end parts 22 are distinct and are connected together by the removable central part 24.

This removable central part 24 is provided with two reversible fastening means 26 capable of interacting with corresponding fastening means of the plastic grille in order to allow said part to be fastened to or removed from the grille.

These fastening means are preferably designed so as to be able to be manipulated by hand so that mounting, like removal, can be carried out by an unqualified person without the aid of tools. In the example, these reversible fastening means 26 are clips. Any other removable fastening means may however be envisaged, such as a system of plastic removable rivets.

In the example, the removable central part has an elongate shape and is provided with two clips 26 (of which only one is shown in the figures) each situated at one end so that each one interacts with an orifice 28 made in each fixed end part 22.

Each clip 26 is formed of a tongue bent in a V shape of which the free end 26a protrudes from the removable part on the opposite side of the scuttle grille, as can be seen in FIG. 3. The V-shaped part of the tongue is therefore situated on one side of the grille, the free end 26a being situated on the other side of the grille. This free end 26a can therefore be taken hold of from the top of the grille and pulled toward the flange of the V secured to the removable part 24 so as to release the clip from the orifice 28 in which it is engaged. It is then sufficient to lift the removable central part to obtain access to pieces situated under the scuttle grille, such as for example the engine filter 14 of the vehicle.

Moreover, in order to seal the scuttle grille along the windshield over the whole width of the latter, the edge of the scuttle grille part is provided with a seal over its whole length in contact with the windshield. This seal is partly situated on the fixed parts (reference 30), and partly on the removable central part (reference 32). The seal 32 of the removable central part also extends along the edges of the central part resting on the fixed end parts 22, the central part partially overlapping each of the end parts so as to completely close off the space between each end part and the removable central part.

1-5. (canceled)

6. A plastic scuttle grill of a vehicle, comprising:
at least one fixed part configured to be rigidly fixed to the vehicle; and
at least one removable part including at least one reversible fastening means for interacting with a corresponding fastening means of the fixed part of the plastic grill to allow fastening or removal of the removable part onto or from at least one fixed part of the grill,
wherein the scuttle grill is made in three distinct parts: two end parts configured to be permanently fixed to the vehicle, which parts are connected together by a removable central part.

7. The plastic scuttle grill as claimed in claim 6, wherein at least one portion of a periphery of the removable part includes a seal.

8. The plastic scuttle grill as claimed in claim 6, wherein the fastening means is configured to be manipulated by hand.

9. The plastic scuttle grill as claimed in claim 6, wherein the fastening means includes clips.

10. The plastic scuttle grill as claimed in claim 9, wherein each clip includes a tongue bent in a V shape of which a free end protrudes from the removable part on the opposite side of the scuttle grill.
